(19) United States
(12) Patent Application Publication
(10) Pub. No.: US 2022/0406130 A1
(43) Pub. Date: Dec. 22, 2022

(54) WARNING METHOD, APPARATUS AND DEVICE, AND STORAGE MEDIUM

(71) Applicant: SENSETIME INTERNATIONAL PTE. LTD., Singapore (SG)

(72) Inventors: Miao OUYANG, Singapore (SG); Xinxin WANG, Singapore (SG)

(21) Appl. No.: 17/363,366

(22) Filed: Jun. 30, 2021

Related U.S. Application Data
(63) Continuation of application No. PCT/IB2021/055691, filed on Jun. 25, 2021.

(30) Foreign Application Priority Data
Jun. 18, 2021 (SG) 10202106589S

(51) Int. Cl. G07F 17/32; G06T 7/00

(52) U.S. Cl. CPC G07F 17/3241; G06T 7/0002; G07F 17/3216; G06T 2207/10016

(57) ABSTRACT

The embodiments disclose a warning method, which includes that: a first image frame sequence obtained by photographing a game table in a prop operating stage of a game is acquired, the game table including at least one placement region configured for token placement; initial information of a token in each the placement region is acquired, the initial information of the token including information of a token placed by a gamer participating in the game before the game enters the prop operating stage; change information of the token in each the placement region in the prop operating stage is detected based on the first image frame sequence and the initial information of the token; and a warning is given based on the change information of the token in each the placement region. The embodiments also provide a warning apparatus and device, and a storage medium.

### CROSS-REFERENCE TO RELATED APPLICATION

This is continuation application of international application PCT/IB2021/055691, filed on 25 Jun. 2021, which claims priority to Singaporean patent application No. 10202106589S, filed with IPOS on 18 Jun. 2021. The contents of international application PCT/IB2021/055691 and Singaporean patent application No. 10202106589S are incorporated herein by reference in their entireties.

### TECHNICAL FIELD

The disclosure relates to the technical field of computer vision, and relates, but not limited, to a warning method, apparatus and device, and a storage medium.

### BACKGROUND

With the constant development of technologies, more and more scenarios have made higher requirements on intelligence. For example, it is expected in a game place that an event occurring in the place may be monitored automatically and a warning may be given automatically in case of an event exception. In a specific example, a gamer of table game is allowed to select a token placement region and place a token in a token placement stage, and after a game prop operating stage is entered, it is not allow to place a new token in the placement region or to take a token away from the placement region, or it is likely to cause the loss to a game place or the gamer. In the traditional art, detection of such an event depends on a real-time judgment of a game manager, and there may be errors or omissions.

### SUMMARY

Embodiments of the disclosure provide a warning method, apparatus and device, and a storage medium.

The technical solutions of the embodiments of the disclosure are implemented as follows.

According to a first aspect, the embodiments of the disclosure provide a warning method, which may include the following operations.

A first image frame sequence obtained by photographing a game table in a prop operating stage of a game is acquired, the game table including at least one placement region configured for token placement.

Initial information of a token in each the placement region is acquired, the initial information of the token including information of a token placed by a gamer participating in the game before the game enters the prop operating stage.

Change information of the token in each the placement region in the prop operating stage is detected based on the first image frame sequence and the initial information of the token.

A warning is given based on the change information of the token in each the placement region.

According to a second aspect, the embodiments of the disclosure provide a warning apparatus, which may include a first acquisition module, a second acquisition module, a detection module, and a warning module.

The first acquisition module may be configured to acquire a first image frame sequence obtained by photographing a game table in a prop operating stage of a game, the game table including at least one placement region configured for token placement.

The second acquisition module may be configured to acquire initial information of a token in each the placement region, the initial information of the token including information of a token placed by a gamer participating in the game before the game enters the prop operating stage.

The detection module may be configured to detect change information of the token in each the placement region in the prop operating stage based on the first image frame sequence and the initial information of the token.

The warning module may be configured to give a warning based on the change information of the token in each the placement region.

According to a third aspect, the embodiments of the application provide a warning device, which may include a memory and a processor. The memory may store a computer program capable of running in the processor. The processor may implement the steps in the above warning method when executing the program.

According to a fourth aspect, the embodiments of the application provide a computer-readable storage medium, in which a computer program may be stored, the computer program implementing the steps in the warning method when executed by a processor.

The technical solutions provided in the embodiments of the disclosure at least have the following beneficial effects.

In the embodiments of the disclosure, the first image frame sequence obtained by photographing the game table in the prop operating stage of the game is acquired at first; then, the initial information of the token in each the placement region is acquired; next, the change information of the token in each the placement region in the prop operating stage is detected based on the first image frame sequence and the initial information of the token; and finally, the warning is given based on the change information of the token in each the placement region. In such a manner, whether the token that the gamer has placed in each placement region before the game prop stage is changed is detected based on a parsing result of images shot in the game prop stage to automatically supervise whether the gamer participating in the game conforms to a game rule in the game prop stage and give a warning, so that the dependence on a game manager is reduced, facilitating to improve the accuracy of supervision and exception warning in a game process.

### BRIEF DESCRIPTION OF THE DRAWINGS

In order to describe the technical solutions of the embodiments of the disclosure more clearly, the drawings required for the descriptions about the embodiments will be briefly introduced below. It is apparent that the drawings described below are merely some embodiments of the disclosure. Other drawings may further be obtained by those of ordinary skill in the art according to these drawings without creative work.

FIG. 1 is a structure diagram of a warning system according to an embodiment of the disclosure.

FIG. 2 is a flowchart of a warning method according to an embodiment of the disclosure.

FIG. 3 is a flowchart of a warning method according to an embodiment of the disclosure.

FIG. 4 is a flowchart of a warning method according to an embodiment of the disclosure.

FIG. 5 is a flowchart of a warning method according to an embodiment of the disclosure.

FIG. 6A is a state flowchart of a game process according to an embodiment of the disclosure.

FIG. 6B is a logic flowchart of a warning method according to an embodiment of the disclosure.

FIG. 7 is a flowchart of chip detection in a gaming stage according to an embodiment of the disclosure.

FIG. 8 is a composition structure diagram of a warning apparatus according to an embodiment of the disclosure.

FIG. 9 is a schematic diagram of hardware entities of a warning device according to an embodiment of the disclosure.

### DETAILED DESCRIPTION

In order to make the objectives, technical solutions and advantages of the embodiments of the disclosure clearer, the technical solutions in the embodiments of the disclosure will be clearly and completely described below in combination with the drawings in the embodiments of the disclosure. It is apparent that the described embodiments are not all but part of embodiments of the disclosure. The following embodiments are adopted to describe the disclosure but not intended to limit the scope of the disclosure. All other embodiments obtained by those of ordinary skill in the art based on the embodiments in the disclosure without creative work shall fall within the scope of protection of the disclosure.

“Some embodiments” involved in the following descriptions describes a subset of all possible embodiments. However, it can be understood that “some embodiments” may be the same subset or different subsets of all the possible embodiments, and may be combined without conflicts.

It is to be pointed out that term “first/second/third” involved in the embodiments of the disclosure is only for distinguishing similar objects and does not represent a specific sequence of the objects. It can be understood that “first/second/third” may be interchanged to specific sequences or orders if allowed to implement the embodiments of the disclosure described herein in sequences except the illustrated or described ones.

Those skilled in the art can understand that, unless otherwise defined, all the terms (including technical terms and scientific terms) used herein have the same meanings usually understood by those of ordinary skill in the art of the embodiments of the disclosure. It should also be understood that terms defined in, for example, a general dictionary, should be understood to have the same meanings as those in the context of the conventional art, and may not be explained as idealized or too formal meanings, unless otherwise specifically defined like those here.

Computer vision: as a science researching how to make machines “see”, computer vision refers to identifying, tracking and measuring targets using video cameras and computers instead of human eyes and further performing image processing.

Image identification technology: the image identification technology may be based on a main feature of an image. Each image has its own feature. For example, letter A has a tip, P has a circle, and Y has an acute angle in the center. Researches on eye movements during image identification show that the light of sight is fixed upon a main feature of an image, that is, a position where a contour curvature of the image is maximum or a contour direction changes suddenly and that has most information. Moreover, a scanning route of the eye always sequentially turns from one feature to another feature. It can thus be seen that a perceptual mechanism needs to exclude input redundant information and extract key information in an image identification process. In addition, a mechanism responsible for information integration in the brain is required to integrate information obtained in stages into a complete perceptual impression.

In a human image identification system, identification of a complex image is usually implemented by using information processing at different layers. For a familiar image, since its main feature is learnt, the image may be identified as a unit, without focusing on its details. Such an integrated unit formed by isolated unit materials is called a block, and each block is perceived at the same time. In identification of a written material, a person may identify not only a block formed by units such as strokes or radical of a Chinese character but also a block unit formed by words or phrases that often appear together.

A warning method provided in the embodiments of the disclosure may be applied to a casino scenario. In the casino scenario, the gamer mentioned anywhere in the embodiments of the disclosure may include a player or a banker, the game controller mentioned anywhere in the embodiments of the disclosure may refer to a dealer, the game table mentioned anywhere in the embodiments of the disclosure may refer to a gambling table, the token mentioned anywhere in the embodiments of the disclosure may include a chip, the placement region mentioned anywhere in the embodiments of the disclosure may refer to a betting region or a anteing region on the game table, the game prop mentioned anywhere in the embodiments of the disclosure may be cards, the game prop operating stage may be a dealing stage, and the management system mentioned anywhere in the embodiments of the disclosure may refer to a Casinos Management System (CMS).

In some implementation modes, the game on the game table may be Baccarat. In some other implementation modes, the game on the game table may be other games, such as Fishing Joy, Texas Poker, one-arm bandit, or show-hand. The game type is not limited in the embodiments of the disclosure. The game on the game table may be a card game or a non-card game.

FIG. 1 is a structure diagram of a warning system according to an embodiment of the disclosure. As shown in FIG. 1, the warning system 100 may include a camera component 101, a warning device 102, and a management system 103.

In some implementation modes, the camera component 101 may include multiple cameras, and the multiple cameras may photograph a game table from different angles.

In some implementation modes, the warning device 102 may correspond to only one camera component 101. In some other implementation modes, the warning device 102 may correspond to multiple camera components 101. For example, the multiple camera components 101 corresponding to the warning device 102 may be camera components 101 configured to photograph game tables in one or more game places, or, the multiple camera components 101 corresponding to the warning device 102 may be camera components 101 configured to photograph game tables in a partial region in a game place. The partial region may be a common region, a Very Important Person (VIP) region, etc.

In some implementation modes, the warning device 102 may be arranged in a game place. For example, the warning device 102 may be connected with a server in the game place. In some other implementation modes, the warning device 102 may be arranged in a cloud.

The camera component 101 may be in communication connection with the warning device 102. In some implementation modes, the camera component 101 may shoot real-time images periodically or aperiodically, and send the shot real-time images to the warning device 102. For example, in a case where the camera component 101 includes multiple cameras, the multiple cameras may shoot real-time images at an interval of a target time length, and send the shot real-time images to the warning device 102. The multiple cameras may shoot real-time images at the same time or at different time. In some other implementation modes, the camera component 101 may shoot real-time videos, and send the real-time videos to the warning device 102. For example, in a case where the camera component 101 includes multiple cameras, the multiple cameras may send shot real-time videos to the warning device 102 respectively such that the warning 102 extracts real-time images from the real-time videos. The real-time image in the embodiments of the disclosure may be any one or more of the following images.

In some implementation modes, the camera component may constantly soot images, thereby continuously sending the shot images to the warning device 102. In some other implementation modes, the camera component may be triggered by a target to shoot an image. For example, the camera component may start shooting an image in response to an instruction that a game result comes out or a token is placed.

The warning device 102 may analyze the token on the game table, as well as a game controller and a gamer at the game table in the game place based on the real-time images to determine whether an action of the game controller and/or the gamer conforms to rules or are proper.

The warning device 102 may be in communication connection with the management system 103. In a case where the warning device 102 determines that the action of the game controller or the gamer is improper, the warning device 102 may send warning information to the management system 103 on the game table corresponding to the game controller or the gamer whose action is improper such that the management system 103 may give a warning corresponding to the warning information to warn the game controller or the gamer through the game table to give an early warning about the situation that the improper action of the game controller or the gamer causes loss to the game place or the gamer, so as to timely correct the action or take other measures.

The embodiments of the disclosure are not limited thereto. In the embodiment corresponding to FIG. 1, the camera component 101, warning device 102 and management system 103 are presented as independent respectively. However, in other embodiments, the camera component 101 and the warning device 102 may integrated, or, the alarming device 102 and the management system 103 may be integrated.

The warning method provided in the embodiments of the disclosure will be described below. According to the method, change information of tokens in multiple placement regions on a game table may be detected in a game prop operating stage, and a warning is given in a case of detecting that a gamer continues placing a token or takes a token away from a certain placement region, so that the situation where an improper action of the gamer or a game controller may cause loss to a game place is reduced.

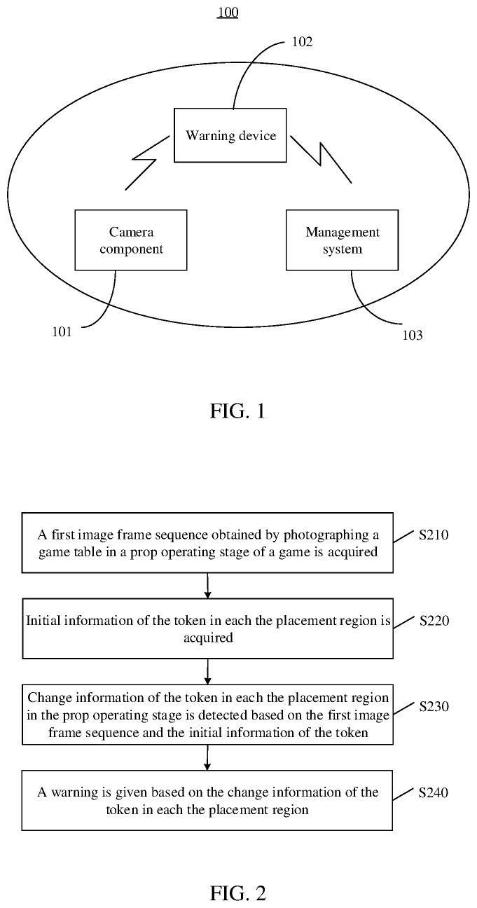

FIG. 2 is a flowchart of a warning method according to an embodiment of the disclosure. As shown in FIG. 2, the method is applied to a warning device and at least includes the following steps.

In S210, a first image frame sequence obtained by photographing a game table in a prop operating stage of a game is acquired.

Here, the game table includes at least one placement region configured for token placement. The at least one placement region may be a token placement region configured to represent at least one token holder on the game table.

In some embodiments, the warning device may include an edge device, an Artificial Intelligence (AI) node, or an edge node. The warning device may be in communication connection with a server in a game place, so that the server may correspondingly control the warning device, and the warning device may use services provided by the server. In some implementation modes, one warning device may be in one-to-one correspondence with one game table. In some other implementation modes, one warning device may correspond to multiple game tables.

In some implementation modes, a camera component may be arranged on the warning device, so that the game table may be photographed through the camera component to obtain the first image frame sequence and a second image frame sequence described below. In some other implementation modes, the camera component and the warning device are arranged separately, and the camera component may photograph the game table and send shot real-time images to the warning device such that the warning device extracts and determines the first image frame sequence and the second image frame sequence described below based on the real-time images.

A process of a round of game may include a token placement stage and a game prop operating stage, and may further include a payout stage. In the token placement stage, each gamer participating in the game may select a placement region representative of a certain party, and place a token therein. In the game prop operating stage, a game controller may operate game props on the game table to obtain a game result. In the payout stage, the game controller may collect the token from the placement region corresponding to a loser, and deliver the token to the placement region of a winner. It is to be noted that, after the game prop operating stage, the gamer is not allowed to continue to place a new token, and the gamer is also not allowed to remove the token in the placement region.

In S220, initial information of the token in each the placement region is acquired.

Here, the initial information of the token includes information of a token placed by a gamer participating in the game before the game enters the prop operating stage. That is, the gamer has placed the token for this game in the corresponding placement region. The information of the token includes, but not limited to, amount, value, type, and confidence of the token.

In some implementation modes, the amount of the token is represented by the number of piles, each pile being formed by stacking a fixed or unfixed amount of tokens. In some implementation modes, the value of the token is represented by a face value, namely a specific numerical face value set on a surface of the token. In some other implementation modes, the value of the token may also be associated with a color thereof. For example, a red token has a face value of 100, and a blue token has a face value of 50. In some implementation modes, the type of the token includes a member type, a non-number type, etc. In some implementation modes, the confidence of the token characterizes the reliability of an identification result. For example, if the confidence of the token is −1, it indicates that the identification result of the token is unreliable and not suitable for subsequent comparison or analysis.

In S230, change information of the token in each the placement region in the prop operating stage is detected based on the first image frame sequence and the initial information of the token.

In some implementation modes, an image parsing result obtained after each frame of image in the first image frame sequence is identified is acquired, and the change information of the token in each the placement region in the prop operating stage is detected based on the image parsing result and the initial information of the token.

In some implementation modes, the image parsing result is obtained from identification on each frame of image in the image frame sequence through a target detection model and a behavior identification model which have been trained. The image parsing result may include identified action and position of a hand, and may also include the identified token in each placement region on the game table. For example, there is a pile of tokens in a placement region A, and there are two piles of tokens in a placement region B.

In S240, a warning is given based on the change information of the token in each the placement region.

It is to be noted that, according to a game rule, the gamer or the game controller is not allowed to move the token that has been placed in the corresponding placement region in the prop operating stage, and if the change information of the token is detected, namely it is detected that the initial information of the token is changed, it indicates that someone breaks the game rule and the game needs to be halted. In the embodiment of the disclosure, after it is determined that the initial information of the token in any placement region is changed, exception warning information may be output to prompt a participant of the game, such as the gamer or the game controller, to correct a rule-breaking behavior to ensure that the game may be played smoothly and regularly.

In some implementation modes, the exception warning information may be output immediately in a case of detecting that a present frame of image includes at least one exceptional placement region of which the initial information of the token is changed. In some other implementation modes, the exceptional warning information is output in a case of detecting that the present frame of image includes at least one exceptional placement region and that the same change of the initial information of the token in the same exceptional placement region is kept in a preset number of frames of image. When to output the exception warning information is not limited in the embodiment of the disclosure.

In some implementation modes, the exception warning information may include or indicate at least one of: an identifier of at least one placement region, and attribute information and warning reason of at least one gamer. The warning reason is, for example, that the gamer removes the token in the corresponding exceptional placement region in the prop operating stage. Therefore, a management system, in a case of receiving the exception warning information, may control an outputting apparatus corresponding to the at least one placement region to work. For example, a display apparatus corresponding to the at least one placement region is controlled to display the attribute information and warning reason of the at least one gamer and/or the warning reason, and/or, a sound production apparatus corresponding to the at least one placement region is controlled to produce a warning tone and/or the warning reason, and/or, a light emitting apparatus corresponding to the at least one placement region is controlled to emit warning light, and/or, a vibration apparatus corresponding to a certain placement region is controlled to generate warning vibration. In some implementation modes, if the attribute information or warning reasons of garners are different, there is a difference in terms of at least one of warning tone, warning light, or warning vibration.

In the embodiment of the disclosure, the first image frame sequence obtained by photographing the game table in the prop operating stage of the game is acquired at first; then, the initial information of the token in each placement region is acquired; next, the change information of the token in each placement region in the prop operating stage is detected based on the first image frame sequence and the initial information of the token; and finally, the warning is given based on the change information of the token in each placement region. In such a manner, whether the token that the garner has placed in each placement region before the game prop stage is changed is detected based on a parsing result of images shot in the game prop stage to automatically supervise whether the garner participating in the game conforms to a game rule in the game prop stage and give a warning, so that the dependence on a game manager is reduced, thereby facilitating to improve supervision and exception warning in a game process.

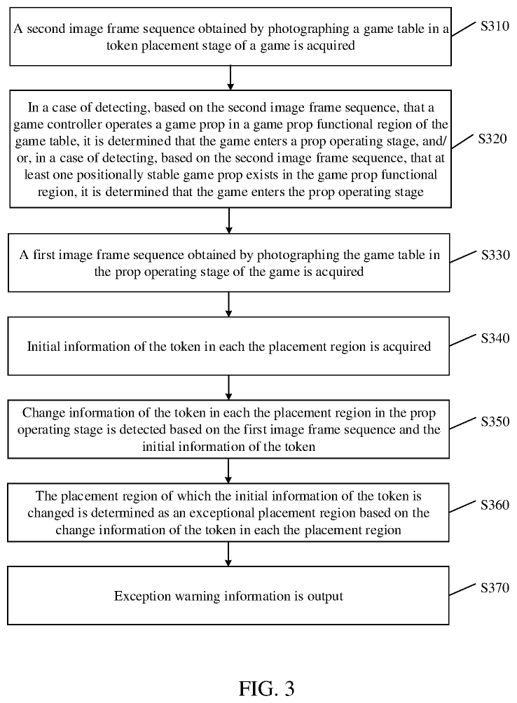

FIG. 3 is a flowchart of a warning method according to an embodiment of the disclosure. As shown in FIG. 3, the method at least includes the following steps.

In S310, a second image frame sequence obtained by photographing a game table in a token placement stage of a game is acquired.

Here, in the token placement stage, a garner may select a placement region representative of a certain party, and place token therein. The second image frame sequence is obtained by photographing a process that the game table enters the token placement stage through a photographic module above or on a side of the game table.

In S320, in a case of detecting, based on the second image frame sequence, that a game controller operates a game prop in a game prop functional region of the game table, it is determined that the game enters a prop operating stage, and/or, in a case of detecting, based on the second image frame sequence, that at least one positionally stable game prop exists in the game prop functional region, it is determined that the game enters the prop operating stage.

Here, the game prop functional region may represent a game result. For example, if the game prop is a playing card, the game prop function region may be a gaming region, and the game result is judged through numbers and suits on playing cards in the gaming region.

Positional stability of the game prop refers to that position information of the same game prop is detected not to change beyond a predetermined fluctuation range in multiple continuous image frames. In such case, it may be considered that a game prop operator (for example, the game controller) has completed the operation on the game prop, and it indicates that the game has entered the game prop operating stage. In a case of detecting that there is the positionally stable game prop in the game prop functional region, it is determined that the game enters the prop operating stage, so that gaming stage judgment logic is simplified, and the detection efficiency can be improved.

It can be understood that, after all gamers have completed operations of placing tokens in corresponding placement regions in a round of game, the game controller starts operating the game prop such that the game enters the prop operating stage. The game controller is a manager or a robot that controls game stages, and collects tokens, and performs payment.

The second image frame sequence may be parsed to detect the action of the game controller of operating the game prop in the game prop functional region of the game table or detect the game prop in the game prop functional region, thereby accurately judging that the game enters the prop operating stage.

In S330, a first image frame sequence obtained by photographing the game table in the prop operating stage of the game is acquired.

Here, the game table includes at least one placement region configured for token placement.

In S340, initial information of the token in each the placement region is acquired.

Here, the initial information of the token includes information of a token placed by a gamer participating in the game before the game enters the prop operating stage. The information of the token includes, but not limited to, the amount, value, type, and confidence of the token.

It is to be noted that, after the game enters the prop operating stage, it indicates that the gamer participating in the game has placed the token in the placement region corresponding to a selected holder. In such case, a warning device may store the initial information of the token in each placement region. For example, the initial information of the token is stored in a cache, and the cache may be cleared when a present round of game is ended and a next round of game is started.

Exemplarily, after the game enters the prop operating stage, it is detected that a pile of type-A tokens is placed in a certain placement region, a face value of a single token being 100 and the amount of tokens in the pile being 5, and initial information of the token, i.e., type A of the pile of tokens, the face value 100 of a single token, the total amount 5 of the tokens, and a total face value 500 of the pile of tokens, may be stored.

In a possible implementation mode, the initial information of the token placed by at least one gamer in each placement region is determined and stored in response to identifying that the game controller operates the game prop for the first time. In another possible implementation mode, the initial information of the token in each placement region is determined and stored after it is identified that all the gamers have completed the placement of the token. In such case, after the game enters the prop operating stage, change information of the token may be monitored timely and accurately based on the stored initial information of the token.

In S350, change information of the token in each the placement region in the prop operating stage is detected based on the first image frame sequence and the initial information of the token.

Here, an image parsing result obtained by identifying each frame of image may be acquired based on the first image frame sequence through a trained target detection model and behavior identification model. The image parsing result may include an identified hand action and a position, and may also include identified token in each placement region on the game table. For example, there is a pile of tokens in a placement region A, and there are two piles of tokens in a placement region B.

In the embodiment of the disclosure, the image parsing result obtained by identifying the first image frame sequence and related to the token and the game prop is acquired at first, and then present information and initial information of the token in each placement region in each frame of image are compared to obtain the change information of the token in each placement region in the prop operating stage.

In S360, the placement region of which the initial information of the token is changed is determined as an exceptional placement region based on the change information of the token in each the placement region.

Here, in a case of detecting that the initial information of the token in a certain placement region is changed, the placement region is continuously tracked as an exceptional placement region to further give a warning.

In S370, exception warning information is output.

Here, the exception warning information is configured to warn about the change information of the token in the exceptional placement region. In the prop operating stage, the case where the token in the exceptional placement region is changed may include one of the following: the gamer or the game controller continues adding a token to at least one placement region, the gamer or the game controller removes the token in at least one placement region, or the gamer or the game controller regulates a type of the token in at least one placement region. During implementation, corresponding warning information may be output for different exceptions to solve problems that the warning information involves as soon as possible to implement efficient management over a game process.

In some implementation modes, first warning information is output in a case where the change information of the token in the exceptional placement region indicates an increase in the total amount of the token and/or an increase in a total value of the token, the first warning information being configured to indicate that a new token is added to the exceptional placement region in the game prop operating stage.

In some other implementation modes, second warning information is output in a case where the change information of the token in the exceptional placement region indicates a decrease in the total amount of the token and/or a decrease in the total value of the token, the second warning information being configured to indicate that the token in the exceptional placement region is removed in the game prop operating stage.

In the embodiment of the disclosure, it is determined, based on the second image frame sequence acquired in the token placement stage, that the game enters the prop operating stage; then the change information of the token in each the placement region in the prop operating stage is detected based on the first image frame sequence acquired in the prop operating stage and the initial information of the token; and finally, based on the change information of the token in each the placement region, the placement region of which the initial information of the token is changed is determined as the exceptional placement region, and the exception warning information is output. Corresponding warning information is output for the change information of the token in different exceptional placement regions to solve problems that the warning information involves as soon as possible to implement efficient management over the game process.

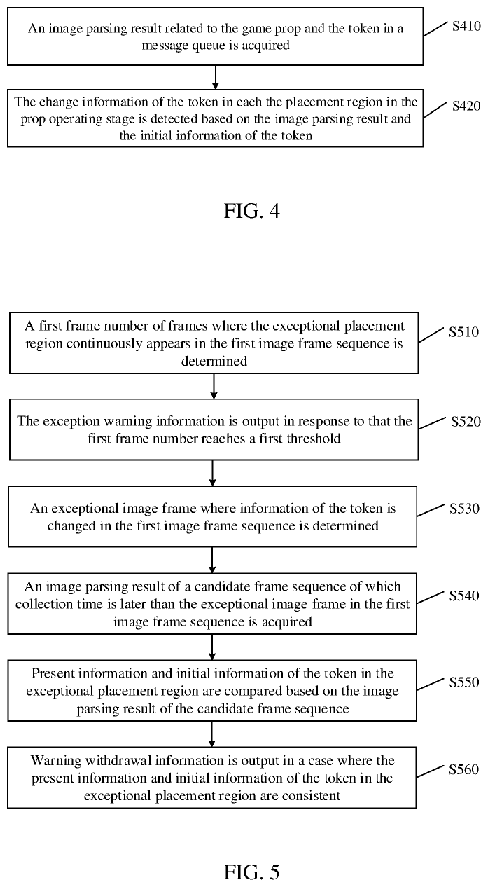

FIG. 4 is a flowchart of a warning method according to an embodiment of the disclosure. As shown in FIG. 4, the method at least includes the following steps.

In S410, an image parsing result related to the game prop and the token in a message queue is acquired.

Here, the image parsing result is obtained by performing at least one of object detection, object identification, or object association relationship detection on the first image frame sequence, and is transmitted to the message queue.

It is to be noted that the warning method is applied to a service layer of the warning device. The warning device further includes a parsing layer and a cache layer. Multiple algorithm models, such as an object detection algorithm, an identification algorithm, and an association algorithm, are configured in the parsing layer to perform image identification on a video sequence collected by a specific camera (arranged above the game table) to obtain the image parsing result of each frame of image. The object detection algorithm is configured to output a target object position (detection box) in an environment and a detection type, including all of tokens, cash, playing cards, human bodies, faces, and hands. The identification algorithm identifies an object of a type according to an output of the object detection algorithm. For example, a token box is given, and a face value and type of a token are identified.

The cache layer is configured to store initial information of the token identified by the parsing layer after the game enters the prop operating stage to subsequently judge whether a person changes the initial information of the token in any placement region in the prop operating stage based on the initial information of the token to achieve a purpose of supervising the game process.

After the game enters the prop operating stage, the service layer acquires the image parsing result identified by the parsing layer and related to the game prop and the token and the initial information of the token stored by the cache layer in real time for service logic processing, and interacts with an internal management system of the game place.

S410 presents a manner of implementing acquisition of the image parsing result related to the game prop and the token through the message queue. Of course, another communication manner such as a socket may also be used for implementation. During practical implementation, the embodiment of the disclosure is not limited to the specific acquisition manner.

In the embodiment of the disclosure, the parsing layer is configured in the warning device to execute identification detection of the first image frame sequence in advance and transmit the image parsing result of each frame of image to the service layer through the message queue, so that the service layer may acquire the image parsing result related to the token and the game prop as required for real-time analysis processing to supervise whether a participant of the game breaks the game rule in real time in the game process.

In S420, the change information of the token in each the placement region in the prop operating stage is detected based on the image parsing result and the initial information of the token.

Here, the present information of the token in each the placement region in each image frame in the first image frame sequence is determined at first based on the image parsing result. Then, the change information of the token in each the placement region is detected based on the initial information and present information of the token in each the placement region.

The initial information of the token in each the placement region is compared with the present information of the token in the corresponding region, in a case where the initial information and present information of the token are consistent, it is determined that the initial information of the token in each placement region in the prop operating stage is not changed, and in a case where the initial information and present information of the token are inconsistent, it is determined that the initial information of the token in each placement region in the prop operating stage is changed. Therefore, an exception in the prop operating stage can be monitored timely and accurately.

In another embodiment, in a case where the image parsing result indicates that the token is associated with a human hand, the change information of the token in each the placement region in the prop operating stage may be detected based on the image parsing result and the initial information of the token.

In some implementation modes, the initial information includes an initial total amount, and the present information includes a present total amount. The change information of the token in each the placement region in the prop operating stage may be detected in the following manner: an initial total amount and a present total amount of the token in each the placement region are compared; it is determined that the total amount of the token in a first placement region where the initial total amount of the token is less than the present total amount increases; and it is determined that the total amount of the token in a second placement region where the initial total amount of the token is greater than the present total amount decreases.

Exemplarily, if the gamer places two piles of tokens in the placement region A in the token placement stage, initial information of the corresponding tokens is that an initial total amount is two piles. Three piles of tokens are detected in the placement region A in a present frame of image shot in the prop operating stage, namely the present total amount is three piles. In such case, it is determined that the total amount of the tokens in the placement region A increases by one pile in the prop operating stage, and it indicates that someone breaks the rule and continues placing tokens in the specific region.

In some implementation modes, the initial information includes the initial total amount and an initial total value, and the present information includes the present total amount and a present total value. The change information of the token in each the placement region in the prop operating stage may be detected in the following manner: in a case where the initial total amount and present total amount of the token in each the placement region are consistent, an initial total value and a present total value of the token in each the placement region are compared; it is determined that a total value of the token in a fifth placement region where the initial total value of the token is less than the present total value of the token increases; and it is determined that a total value of the token in a sixth placement region where the initial total value of the token is greater than the present total value of the token decreases.

Exemplarily, if the gamer places one pile of tokens valued to be 50 in the placement region B in the token placement stage, initial information of the corresponding token is that an initial total amount is one pile and an initial total value is 50. A pile of tokens valued to be 100 is detected in the placement region B in the present frame, namely a present total amount is one pile and a present total value is 100. In such case, it is determined that, in the prop operating stage, the total amount of the token in the placement region B keeps unchanged but the total value increases, and it indicates that someone breaks the rule and replaces the token in the placement region B.

In some implementation modes, the initial information includes the initial total value, and the present information includes the present total value. The change information of the token in each the placement region in the prop operating stage may be detected in the following manner: the initial total value and the present total value of the token in each the placement region are compared; it is determined that a total value of the token in a third placement region where the initial total value of the token is less than the present total value increases; and it is determined that a total value of the token in a fourth placement region where the initial total value of the token is greater than the present total value decreases.

In the embodiment of the disclosure, it may be determined conveniently that the initial information of the token in the corresponding placement region is changed by determining by comparison that the initial total amount of the token in each placement region is inconsistent with the present total amount of the token in the corresponding placement region and/or determining by comparison that the initial total value of the token in each placement region is inconsistent with the present total value of the token in the corresponding placement region. If it is determined that the initial information of the token in the corresponding placement region increases, it indicates that someone continues placing a new token in the corresponding placement region in the prop operating stage. If it is determined that the initial information of the token in the corresponding placement region decreases, it indicates that the token in the placement region is removed. Therefore, irregular actions in the prop operating stage are detected effectively.

FIG. 5 is a flowchart of a warning method according to an embodiment of the disclosure. As shown in FIG. 5, the method includes the following steps.

In S510, a first frame number of frames where the exceptional placement region continuously appears in the first image frame sequence is determined.

Here, there may be one or more exceptional placement regions of which the initial information of the token is changed in a certain image frame in the first image frame sequence. The initial information of the token in some exceptional placement regions may be changed by reasons, such as relatively dark shooting light or occlusions, rather than human factors, so false identification results may be obtained to cause misjudgments of a detection logic.

Therefore, in the embodiment of the disclosure, after a target region in a present frame is detected, whether the exceptional placement region still appears in subsequently collected image frames is continuously tracked, and the first frame number of the frames where the exceptional placement region continuously appears is counted for further judgment.

In S520, the exception warning information is output in response to that the first frame number reaches a first threshold.

Here, the first threshold N is preset, N being an integer more than or equal to 2. For example, N is 19. In a case where the initial information of the token in the exceptional placement region is changed and the change information is kept consistent in N continuous frames, the exception warning information is output to indicate that the initial information of the token in the exceptional placement region is changed.

Different exception warning information may be output for different change information of the token to indicate warning reasons. For example, in some implementation modes, first warning information is output in a case where the initial total amount or total value of the token in the exceptional placement region increases, the first warning information being configured to indicate that a new token is added to the exceptional placement region in the prop operating stage. In some other implementation modes, second warning information is output in a case where the initial total amount or total value of the token in the exceptional placement region decreases, the second warning information being configured to indicate that the token in the exceptional placement region is removed in the prop operating stage.

In the embodiment of the disclosure, target warning information is output only when the first frame number of frames where a target region continuously appears in the image frame sequence satisfies the first threshold, so that misjudgments caused by relatively dark light, occlusions, etc., in individual image frames may be reduced, and furthermore, irregular actions in a gaming process are detected effectively.

In S530, an exceptional image frame where information of the token is changed in the first image frame sequence is determined.

Here, when it is detected that the initial information of the token in a certain placement region is changed, the present frame of image is determined as an exceptional image frame to judge whether removed token is placed back or whether the added token is removed while taking the exceptional image frame as a time reference.

In S540, an image parsing result of a candidate frame sequence of which collection time is later than the exceptional image frame in the first image frame sequence is acquired.

Here, the candidate frame sequence is at least one frame of image collected after the exceptional image frame in the first image frame sequence. The candidate frame sequence may be an image frame collected in the prop operating stage, or an image frame collected in a payout stage after the prop operating stage.

The parsing layer of the warning device may perform constant detection and identification on collected image frame sequences, and send image parsing results to the service layer through the message queue. The service layer acquires the image parsing result of the subsequent candidate frame sequence based on the determined exceptional image frame.

In S550, present information and initial information of the token in the exceptional placement region are compared based on the image parsing result of the candidate frame sequence.

Here, the present information of the token in the exceptional placement region in the candidate frame sequence may be compared whether to be consistent with the stored initial information based on the stored initial information of the token in the exceptional placement region, thereby determining that the information of the exceptional placement region is recovered.

In S560, warning withdrawal information is output in a case where the present information and initial information of the token in the exceptional placement region are consistent.

It is to be noted that, in the embodiment of the disclosure, the exception warning information is output when the initial information of the token in the exceptional placement region is changed in the prop operating stage. The warning withdrawal information may be output in the prop operating stage, or may be output in the payout stage or other stages after the prop operating stage. The warning withdrawal information is output as long as the removed token is placed back in the exceptional placement region or the added token is removed.

In some implementation modes, a second frame number of frames where the exceptional placement region continuously appears in the candidate frame sequence is determined, and the warning withdrawal information is output in response to that the second frame number reaches a second threshold. In such a manner, it is determined that the number of continuous image frames where the same exceptional placement region exists reaches the second threshold, so that misjudgments caused by relatively dark light, occlusions, etc., in individual image frames may be reduced, and whether the gaming process is regular is supervised effectively.

In some implementation modes, the second threshold is less than the first threshold. For example, the first threshold is 19, and the second threshold is 4. In such case, a warning may be given more timely when it is detected that the initial information of the token is changed, and it may be determined accurately that the initial information of the token is actually recovered when the warning is withdrawn, so that the whole supervision process is more efficient and feasible.

In the embodiment of the disclosure, the initial information of the token in the exceptional placement region is stored through the cache layer after the exception warning information is output for the exceptional placement region. It is determined, based on that the present information and initial information of the token in the exceptional placement region are consistent in the subsequent candidate frame sequence, that the initial information of the token in the exceptional placement region is recovered, and in such case, the warning withdrawal information may be output, to ensure that the game may be played normally.

The warning method will be described below in combination with a specific embodiment. However, it is to be noted that the specific embodiment is only for describing the disclosure better and does not form improper limits to the disclosure.

A conventional casino is relatively low in intelligence degree, control of a game process and payment depends on the dealer only, and it is unlikely to track and judge irregular actions. The embodiment of the disclosure proposes deployment of an intelligent casino scenario based on a computer vision technology, and a cloud device and multiple extensible AI nodes are arranged. Each AI node includes an edge computing node, which runs a set of intelligent casino service to control the overall progress of a game on a game table (also called a gaming table), implement effective tracking and warning on irregular actions of the dealer or gamers and reduce the human cost on one hand, and on the other hand, to automatically count the overall game condition (incomes and the number of tables in use) of the casino to assist the manager in making decisions.

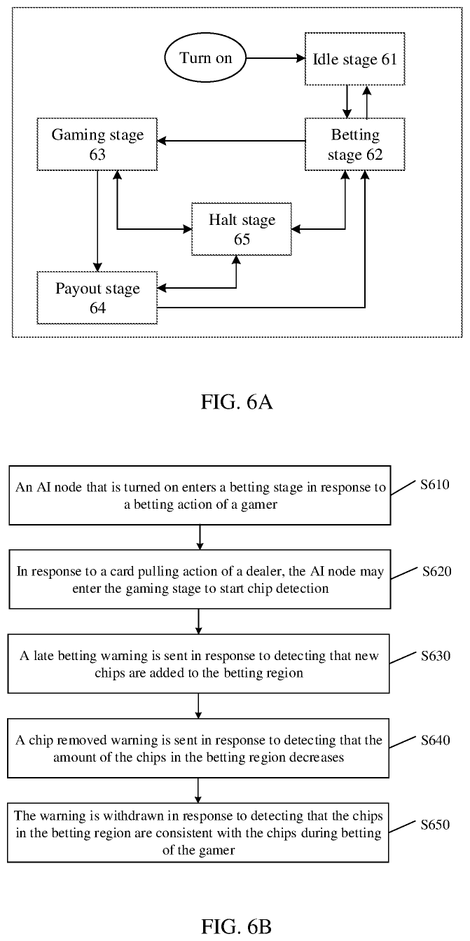

In the embodiment of the disclosure, descriptions are made taking Baccarat (a card game) as an example. FIG. 6A is a state flowchart of a game process according to an embodiment of the disclosure. As shown in FIG. 6A, the AI node monitoring a game table is divided into five stages: an idle stage 61 (idle), a betting stage 62 (betting), a gaming stage 63 (gaming), a payout stage 64 (payout), and a halt stage 65 (halt). The idle stage 61 is a state after a service system is powered on, and in this state, the system may not send any service data or warning information to another intelligent system of the casino. The betting stage 62 is equivalent to the abovementioned token placement stage, and this stage is a stage where all gamers place corresponding chips in betting regions. The gaming stage 63 is equivalent to the abovementioned prop operating stage, such as a stage where the dealer deals cards, and in this stage, all the gamers are not allowed to bet. The payout stage 64 is a stage where a result of a round of game has come out and the dealer starts paying or collecting chips. The halt stage 65 is a state that the service system enters when a card dealing operation of the dealer does not conform to the rule of Baccarat or the specification of the casino. All the betting stage 62, the gaming stage 63 and the payout stage 64 may jump to the halt stage 65 due to irregular operations. In the halt stage 65, objects on the table may still be detected and identified, some service processing may be performed, and service data or warning information may be sent to the other intelligent system of the casino.

The dealer draws four to six cards from three to eight decks of shuffled cards, and a winner-loser result may be obtained according to a rule. The winner-loser result is classified into: player-win, banker-win, tie, etc. Gained or paid money of the gamer and the casino is calculated according to the winner-loser result of each round of game, odds in different scenarios, and whether to take commissions. There are certain rules for card dealing of the dealer and peeking of the gamer, and if the rules are broken, the monitoring system needs to output warning information.

After the dealer pulls the cards, no one is allowed to bet on a betting region or remove the chips in the betting region. For detecting whether the gamer or the dealer conforms the game rule, image identification is performed on the chips on the table, the gamer and the dealer through the AI nodes to obtain inferred chip increment data (equivalent to the initial information of the token). Therefore, whether to send a warning and whether to withdraw the warning are judged according to the chip increment data.

In the embodiment of the disclosure, an event occurring on the table is detected using at least one camera, and is converted into computer information and transmitted to the parsing layer for detection and identification, and finally, the service layer acquires an identification result for further analysis processing.

FIG. 6B is a logic flowchart of a warning method according to an embodiment of the disclosure.

In S610, an AI node that is turned on enters a betting stage in response to a betting action of a gamer.

In the betting stage, all gamers place specific numbers of piles of chips in corresponding betting regions to complete betting.

In S620, in response to a card pulling action of a dealer, the AI node may enter the gaming stage to start chip detection.

Here, card pulling may also be called card dealing. When the dealer starts card pulling, namely deals a first card, chip detection (no more bet) is started. Chip detection is no more bet testing usually used in a casino.

When the dealer is prepared for card pulling, chip increment data inferred by the parsing layer is cached to detect whether the amount of the chips in the betting region increases or decreases in the gaming stage by comparison based on the cached chip increment data.

In S630, a late betting warning is sent in response to detecting that new chips are added to the betting region.

Here, late betting refers to betting after the playing cards are dealt in the gaming stage, and is an irregular betting manner.

During card pulling of the dealer, the gamer or the dealer is prevented from contacting the chips in the betting region. A warning is required to be sent timely in response to detecting that chip data of the betting region is changed, and in such case, the AI node jumps from the gaming stage 63 to the halt stage 65. Therefore, whether the dealer and the gamer conform to the game rule is supervised. For example, when the gamer or the dealer adds a pile of chips to the betting region, the AI node may send the late betting warning (equivalent to a late placement warning) to make a prompt that a person is adding chips to the betting region. When the added pile of chips are removed, the warning may be withdrawn automatically.

In S640, a chip removed warning is sent in response to detecting that the amount of the chips in the betting region decreases.

Here, chip removed refers to that the chips in the betting region are removed after the cards are dealt in the gaming stage, and is an irregular operation manner. Therefore, when the gamer or the dealer removes the chips in the betting region, the chip removed warning (equivalent to a token removed warning) may be sent to make a prompt that a person is taking the chips away from the betting region.

In S650, the warning is withdrawn in response to detecting that the chips in the betting region are consistent with the chips during betting of the gamer.

After the warning is sent, the warning may be withdrawn automatically as long as the added chips are removed or the removed chips are placed back. Therefore, manual processing can be reduced, and the management efficiency of the casino can be improved.

A parsing layer and a service layer are configured in the AI node provided in the embodiment of the disclosure. The parsing layer includes multiple algorithm models, such as an object detection algorithm, an identification algorithm, and an association algorithm, which are configured to perform image identification on a video sequence collected by a specific camera (arranged above the game table) to obtain an identification result of each frame of image. The service layer acquires the identification result from the parsing layer for service logic processing, and interacts with an internal system of the casino. In a chip detection process, the parsing layer identifies each frame of image in the image frame sequence, and inputs the identification result of each frame of image to a message queue, and the service layer acquires the identification result of each frame of image from the message queue.

The chip detection process is executed by the service layer. The service layer extracts each frame from the message queue, and compares chip data of each betting region in a present frame and chip data, stored in a cache, of the corresponding region. The chip data may include a chip pile amount and/or a chip value. If a comparison result indicates that the chip data of a certain betting region is changed and it is further determined that this change of the chip data of the betting region is kept in a plurality of continuous frames of images, a warning is sent to the betting region.

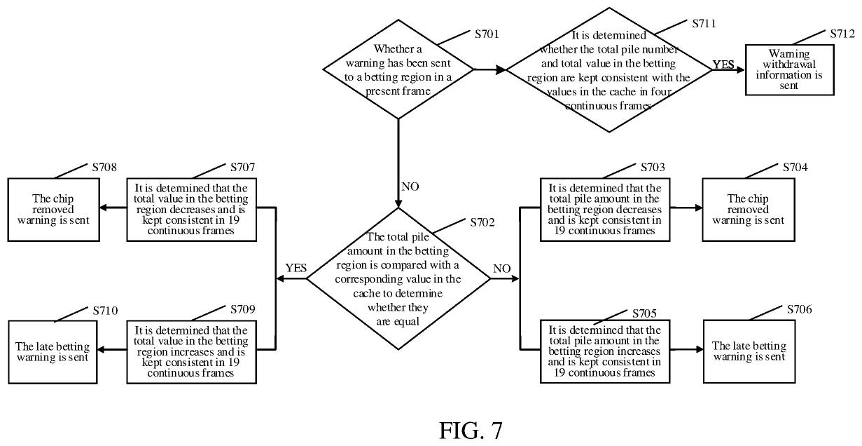

FIG. 7 is a flowchart of chip detection in a gaming stage according to an embodiment of the disclosure. The total pile amount represents the total amount of piles of chips in each betting region, and the total value represents a total value of the chips in each betting region. As shown in FIG. 7, the detection flow includes the following steps.

In S701, whether a warning has been sent to a betting region in a present frame is judged.

Here, judgment is made for each betting region in the present frame. The fact that the warning has been sent to the betting region may refer to that the chip removed warning (equivalent to first warning information) has been sent, or that the late betting warning (equivalent to second warning information) has been sent.

If no warning has been sent to the betting region, S703 to S710 are executed. If the warning has been sent to the betting region, S711 to S712 are executed.

In S702, the total pile amount in the betting region is compared with a corresponding value in the cache to determine whether they are equal.

If the total pile amount of the chips is unequal to the value in the cache, S703 to S706 are executed. If the total pile amount of the chips is equal to the value in the cache, S707 to S710 are executed.

In S703, it is determined that the total pile amount in the betting region decreases and is kept consistent in 19 continuous frames.

In S704, the chip removed warning is sent.

In S705, it is determined that the total pile amount in the betting region increases and is kept consistent in 19 continuous frames.

In S706, the late betting warning is sent.

In S707, it is determined that the total value in the betting region decreases and is kept consistent in 19 continuous frames.

In S708, the chip removed warning is sent.

In S709, it is determined that the total value in the betting region increases and is kept consistent in 19 continuous frames.

In S710, the late betting warning is sent.

In S711, it is determined whether the total pile amount and total value in the betting region are kept consistent with the values in the cache in four continuous frames.

In S712, warning withdrawal information is sent.

If it is determined that the total value of the chips in the betting region in the present frame is kept unchanged, the next frame in the message queue is continued to be processed according to S701 to S712.

In the embodiment of the disclosure, the AI node may detect whether the chips in the betting region are changed after card pulling of the dealer according to the chip increment data inferred by the parsing layer, and when the chips in the betting region are changed, the warning may be sent immediately, so that the management efficiency of the casino is improved. In addition, after the warning is sent, the warning may be withdrawn automatically as long as the added chips are removed or the removed chips are placed back, so that manual processing is reduced.

Based on the abovementioned embodiments, the embodiments of the disclosure also provide a warning apparatus. Each module of the apparatus and each submodule and each unit of each module may be implemented through a processor in the warning apparatus, and of course, may also be implemented through a specific logic circuit. In an implementation process, the processor may be a Central Processing Unit (CPU), a Micro Processing Unit (MPU), a Digital Signal Processor (DSP), a Field Programmable Gate Array (FPGA), etc.

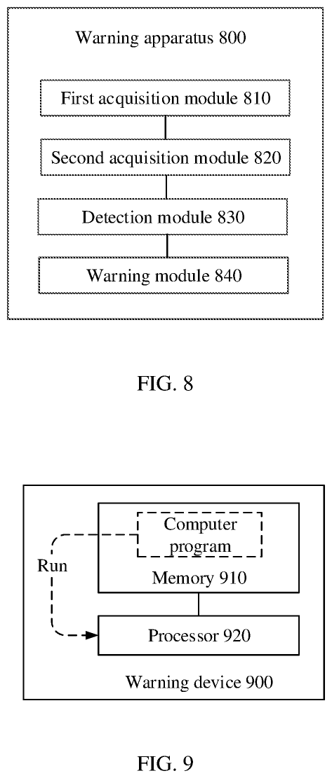

FIG. 8 is a composition structure diagram of a warning apparatus according to an embodiment of the disclosure. As shown in FIG. 8, the warning apparatus 800 includes a first acquisition module 810, a second acquisition module 820, a detection module 830, and a warning module 840.

The first acquisition module 810 is configured to acquire a first image frame sequence obtained by photographing a game table in a prop operating stage of a game, the game table including at least one placement region configured for token placement.

The second acquisition module 820 is configured to acquire initial information of a token in each the placement region, the initial information of the token including information of a token placed by a gamer participating in the game before the game enters the prop operating stage.

The detection module 830 is configured to detect change information of the token in each the placement region in the prop operating stage based on the first image frame sequence and the initial information of the token.

The warning module 840 is configured to give a warning based on the change information of the token in each the placement region.

In some possible embodiments, the warning apparatus 800 further includes a third acquisition module and a determination module. The third acquisition module is configured to acquire a second image frame sequence obtained by photographing the game table in a token placement stage of the game. The determination module is configured to: in a case of detecting, based on the second image frame sequence, that a game controller operates a game prop in a game prop functional region of the game table, determine that the game enters the prop operating stage; and/or, in a case of detecting, based on the second image frame sequence, that at least one positionally stable game prop exists in the game prop functional region, determine that the game enters the prop operating stage.

In some possible embodiments, the warning module 840 includes a region determination submodule and a warning outputting submodule. The region determination submodule is configured to determine a placement region of which the information of the token is changed as an exceptional placement region based on the change information of the token in each the placement region. The warning outputting submodule is configured to output exception warning information, the exception warning information being configured to warn about the change information of the token in the exceptional placement region.

In some possible embodiments, the exception warning information includes first warning information and second warning information, and the warning outputting submodule includes a first outputting unit and a second outputting unit. The first outputting unit is configured to output the first warning information in a case where the change information of the token in the exceptional placement region indicates an increase in a total amount of the token and/or an increase in a total value of the token, the first warning information being configured to indicate that a new token is added to the exceptional placement region in the game prop operating stage. The second outputting unit is configured to output second warning information in a case where the change information of the token in the exceptional placement region indicates a decrease in the total amount of the token and/or a decrease of the total value of the token, the second warning information being configured to indicate that the token in the exceptional placement region is removed in the game prop operating stage.

In some possible embodiments, the detection module 830 includes a first acquisition submodule and a detection submodule. The first acquisition submodule is configured to acquire an image parsing result related to a game prop and the token in a message queue, the image parsing result being obtained from at least one of object detection, object identification, or object association relationship detection on the first image frame sequence and being transmitted to the message queue. The detection submodule is configured to detect the change information of the token in each the placement region in the prop operating stage based on the image parsing result and the initial information of the token.

In some possible embodiments, the detection submodule is further configured to, in a case where the image parsing result indicates that the token is associated with a human hand, detect the change information of the token in each the placement region in the prop operating stage based on the image parsing result and the initial information of the token.

In some possible embodiments, the detection submodule includes a first determination unit and a detection unit. The first determination unit is configured to determine present information of the token in each the placement region in each image frame in the first image frame sequence based on the image parsing result. The detection unit is configured to detect the change information of the token in each the placement region based on the initial information and the present information of the token in each the placement region.

In some possible embodiments, the initial information includes an initial total amount, and the present information includes a present total amount. The detection unit is further configured to compare an initial total amount and a present total amount of the token in each the placement region, determine an increase in the total amount of the token in a first placement region where the initial total amount of the token is less than the present total amount, and determine a decrease in the total amount of the token in a second placement region where the initial total amount of the token is greater than the present total amount.

In some possible embodiments, the initial information includes an initial total value, and the present information includes a present total value. The detection unit is further configured to compare an initial total value and a present total value of the token in each the placement region, determine an increase in a total value of the token in a third placement region where the initial total value of the token is less than the present total value, and determine a decrease in a total value of the token in a fourth placement region where the initial total value of the token is greater than the present total value.

In some possible embodiments, the initial information further includes an initial total value, and the present information further includes a present total value. The detection unit is further configured to: in a case where the initial total amount and the present total amount of the token in each the placement region are consistent, compare an initial total value and a present total value of the token in each the placement region, determine an increase in a total value of the token in a fifth placement region where the initial total value of the token is less than the present total value of the token, and determine a decrease in a total value of the token in a sixth placement region where the initial total value of the token is greater than the present total value of the token.

In some possible embodiments, the warning outputting submodule is further configured to determine a first frame number of frames where the exceptional placement region continuously appears in the candidate frame sequence, and output the exception warning information in response to that the first frame number reaches a first threshold.

In some possible embodiments, the warning module 840 further includes an image frame determination submodule, a second acquisition submodule, a comparison submodule, and a warning withdrawal submodule. The image frame determination submodule is configured to determine an exceptional image frame where information of the token is changed in the first image frame sequence. The second acquisition submodule is configured to acquire an identification result of a candidate frame sequence of which collection time is later than the exceptional image frame in the first image frame sequence. The comparison submodule is configured to compare the present information and the initial information of the token in the exceptional placement region based on the identification result of the candidate frame sequence. The warning withdrawal submodule is configured to output warning withdrawal information in a case where the present information and the initial information of the token in the exceptional replacement region are consistent.

In some possible embodiments, the warning withdrawal submodule includes a second determination unit and an information outputting unit. The second determination unit is configured to determine a second frame number of frames where the exceptional placement region continuously appears in the candidate frame sequence, and output the warning withdrawal information in response to that the second frame number reaches a second threshold, the second threshold being less than the first threshold.

It is to be pointed out that descriptions about the above apparatus embodiment are similar to descriptions about the method embodiment and beneficial effects similar to those of the method embodiment are achieved. Technical details undisclosed in the apparatus embodiments of the disclosure may be understood with reference to the descriptions about the method embodiments of the disclosure.

It is to be noted that, in the embodiments of the disclosure, when implemented in form of a software function module and sold or used as an independent product, the warning method may also be stored in a computer-readable storage medium. Based on such an understanding, the technical solutions of the embodiments of the disclosure substantially or parts making contributions to the related art may be embodied in form of a software product. The computer software product is stored in a storage medium, including a plurality of instructions configured to enable a warning device to execute all or part of the method in each embodiment of the disclosure. The storage medium includes various media capable of storing program codes such as a U disk, a mobile hard disk, a Read Only Memory (ROM), a magnetic disk or an optical disk. Therefore, the embodiments of the disclosure are not limited to any specific hardware and software combination.

Correspondingly, the embodiments of the application provide a computer-readable storage medium, in which a computer program is stored, the computer program being executed by a processor to implement the steps in the warning method as described in any abovementioned embodiment. Correspondingly, there is also provided a chip in the embodiments of the disclosure. The chip includes a programmable logic circuit and/or a program instruction. The chip, when running, is configured to implement the steps in the warning method as described in any abovementioned embodiment. Correspondingly, there is also provided a computer program product in the embodiments of the disclosure. The computer program product, when run by a processor of a warning device, is configured to implement the steps in the warning method as described in any abovementioned embodiment.

Based on the same technical concept, the embodiments of the disclosure provide a warning device, which is configured to implement a warning method recorded in the method embodiments. FIG. 9 is a schematic diagram of hardware entities of a warning device according to an embodiment of the disclosure. As shown in FIG. 9, the warning device 900 includes a memory 910 and a processor 920. The memory 910 stores a computer program capable of running in the processor 920. The processor 920 executes the program to implement the steps in any warning method as described in the embodiments of the disclosure.

The memory 910 is configured to store an instruction and application executable for the processor 920, may also cache data (for example, image data, video data, voice communication data and video communication data) to be processed or having been processed by the processor 920 and each module in the warning device 400, and may be implemented through a flash or a Random Access Memory (RAM).

The processor 920 executes the program to implement the steps of any abovementioned warning method. The processor 920 usually controls overall operations of the warning device 900.

The processor may be at least one of an Application Specific Integrated Circuit (ASIC), a Digital Signal Processor (DSP), a Digital Signal Processing Device (DSPD), a Programmable Logic Device (PLD), an FPGA, a CPU, a controller, a microcontroller, or an MCU. It can be understood that other electronic devices may also be configured to realize functions of the processor, and no specific limits are made in the embodiments of the disclosure.

The computer storage medium/memory may be a memory such as a ROM, a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a flash memory, a magnetic surface memory, an optical disk, or a Compact Disc Read-Only Memory (CD-ROM), or may be any warning device including one or any combination of the abovementioned memories, such as a mobile phone, a computer, a tablet device, and a personal digital assistant.

It is to be pointed out here that the above descriptions about the storage medium and device embodiments are similar to the descriptions about the method embodiment and beneficial effects similar to those of the method embodiment are achieved. Technical details undisclosed in the storage medium and device embodiments of the disclosure are understood with reference to the descriptions about the method embodiment of the disclosure.

It is to be understood that “one embodiment” and “an embodiment” mentioned in the whole specification mean that specific features, structures or characteristics related to the embodiment is included in at least one embodiment of the disclosure. Therefore, “in one embodiment” or “in an embodiment” mentioned throughout the specification does not always refer to the same embodiment. In addition, these specific features, structures or characteristics may be combined in one or more embodiments freely as appropriate. It is to be understood that, in each embodiment of the disclosure, a magnitude of a sequence number of each process does not mean an execution sequence and the execution sequence of each process should be determined by its function and an internal logic and should not form any limit to an implementation process of the embodiments of the disclosure. The sequence numbers of the embodiments of the disclosure are adopted not to represent superiority-inferiority of the embodiments but only for description.

It is to be noted that terms “include” and “contain” or any other variant thereof is intended to cover nonexclusive inclusions herein, so that a process, method, object or device including a series of elements not only includes those elements but also includes other elements which are not clearly listed or further includes elements intrinsic to the process, the method, the object or the device. In a case of no more limitations, an element defined by the statement “including a/an . . . ” does not exclude existence of the same other elements in a process, method, object or device including the element.

In some embodiments provided by the disclosure, it is to be understood that the disclosed device and method may be implemented in another manner. The device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part of all of the units may be selected according to a practical requirement to achieve the purposes of the solutions of the embodiments of the disclosure.

In addition, each function unit in each embodiment of the disclosure may be integrated into a processing unit, each unit may also serve as an independent unit and two or more than two units may also be integrated into a unit. The integrated unit may be implemented in a hardware form and may also be implemented in form of hardware and software function unit.

Or, when implemented in form of a software function module and sold or used as an independent product, the integrated unit of the disclosure may also be stored in a computer-readable storage medium. Based on such an understanding, the technical solutions of the embodiments of the disclosure substantially or parts making contributions to the related art may be embodied in form of a software product. The computer software product is stored in a storage medium, including a plurality of instructions configured to enable an automatic test line of a device to execute all or part of the method in each embodiment of the disclosure. The storage medium includes: various media capable of storing program codes such as a mobile hard disk, a ROM, a magnetic disk, or an optical disc.

The methods disclosed in some method embodiments provided in the disclosure may be freely combined without conflicts to obtain new method embodiments.

The characteristics disclosed in some method or device embodiments provided in the disclosure may be freely combined without conflicts to obtain new method embodiments or device embodiments.

The above is only the implementation mode of the disclosure and not intended to limit the scope of protection of the disclosure. Any variations or replacements apparent to those skilled in the art within the technical scope disclosed by the disclosure shall fall within the scope of protection of the disclosure. Therefore, the scope of protection of the disclosure shall be subject to the scope of protection of the claims.

1. A warning method, comprising:
acquiring a first image frame sequence obtained by photographing a game table in a prop operating stage of a game, wherein the game table comprises at least one placement region configured for token placement;
acquiring initial information of a token in each the placement region, wherein the initial information of the token comprises information of a token placed by a gamer participating in the game before the game enters the prop operating stage;
detecting change information of the token in each the placement region in the prop operating stage based on the first image frame sequence and the initial information of the token; and
giving a warning based on the change information of the token in each the placement region.

2. The method of claim 1, further comprising:
acquiring a second image frame sequence obtained by photographing the game table in a token placement stage of the game; and
performing at least one of following operations:
in a case of detecting, based on the second image frame sequence, that a game controller operates a game prop in a game prop functional region of the game table, determining that the game enters the prop operating stage; and
in a case of detecting, based on the second image frame sequence, that at least one positionally stable game prop exists in the game prop functional region, determining that the game enters the prop operating stage.

3. The method of claim 1, wherein giving the warning based on the change information of the token in each the placement region comprises:
determining a placement region of which the initial information of the token is changed as an exceptional placement region based on the change information of the token in each the placement region; and
outputting exception warning information, wherein the exception warning information is configured to warn about the change information of the token in the exceptional placement region.

4. The method of claim 3, wherein the exception warning information comprises first warning information and second warning information;
wherein outputting the exception warning information comprises:
outputting the first warning information in a case where the change information of the token in the exceptional placement region indicates an increase in at least one of a total amount of the token or a total value of the token, wherein the first warning information is configured to indicate that a new token is added to the exceptional placement region in the game prop operating stage; and
outputting second warning information in a case where the change information of the token in the exceptional placement region indicates a decrease in at least one of the total amount of the token or the total value of the token, wherein the second warning information is configured to indicate that the token in the exceptional placement region is removed in the game prop operating stage.

5. The method of claim 1, wherein detecting the change information of the token in each the placement region in the prop operating stage based on the first image frame sequence and the initial information of the token comprises:
acquiring an image parsing result related to a game prop and the token in a message queue, wherein the image parsing result is obtained from at least one of object detection, object identification, or object association relationship detection on the first image frame sequence and is transmitted to the message queue; and
detecting the change information of the token in each the placement region in the prop operating stage based on the image parsing result and the initial information of the token.

6. The method of claim 5, wherein detecting the change information of the token in each the placement region in the prop operating stage based on the image parsing result and the initial information of the token comprises:
in a case where the image parsing result indicates that the token is associated with a human hand, detecting the change information of the token in each the placement region in the prop operating stage based on the image parsing result and the initial information of the token.

7. The method of claim 5, wherein detecting the change information of the token in each the placement region in the prop operating stage based on the image parsing result and the initial information of the token comprises:
determining present information of the token in each the placement region in each image frame in the first image frame sequence based on the image parsing result; and
detecting the change information of the token in each the placement region based on the initial information and the present information of the token in each the placement region.

8. The method of claim 7, wherein the initial information comprises an initial total amount, and the present information comprises a present total amount;
wherein detecting the change information of the token in each the placement region based on the initial information and the present information of the token in each the placement region comprises:
comparing an initial total amount and a present total amount of the token in each the placement region;
determining an increase in the total amount of the token in a first placement region where the initial total amount of the token is less than the present total amount; and
determining a decrease in the total amount of the token in a second placement region where the initial total amount of the token is greater than the present total amount.

9. The method of claim 7, wherein the initial information comprises an initial total value, and the present information comprises a present total value;
wherein detecting the change information of the token in each the placement region based on the initial information and the present information of the token in each the placement region comprises:
comparing an initial total value and a present total value of the token in each the placement region;
determining an increase in a total value of the token in a third placement region where the initial total value of the token is less than the present total value; and
determining a decrease in a total value of the token in a fourth placement region where the initial total value of the token is greater than the present total value.

10. The method of claim 8, wherein the initial information further comprises an initial total value, and the present information further comprises a present total value;
wherein detecting the change information of the token in each the placement region based on the initial information and the present information of the token in each the placement region further comprises:
in a case where the initial total amount and the present total amount of the token in each the placement region are consistent, comparing an initial total value and a present total value of the token in each the placement region;
determining an increase in a total value of the token in a fifth placement region where the initial total value of the token is less than the present total value of the token; and
determining a decrease in a total value of the token in a sixth placement region where the initial total value of the token is greater than the present total value of the token.

11. The method of claim 3, wherein outputting the exception warning information comprises:
determining a first frame number of frames where the exceptional placement region continuously appears in the first image frame sequence; and
in response to that the first frame number reaches a first threshold, outputting the exception warning information.

12. The method of claim 3, after outputting the exception warning information, further comprising:
determining an exceptional image frame where information of the token is changed in the first image frame sequence;
acquiring an image parsing result of a candidate frame sequence of which collection time is later than the exceptional image frame in the first image frame sequence;
comparing the present information and the initial information of the token in the exceptional placement region based on the image parsing result of the candidate frame sequence; and
in a case where the present information and the initial information of the token in the exceptional placement region are consistent, outputting warning withdrawal information.

13. The method of claim 12, wherein outputting the warning withdrawal information comprises:
determining a second frame number of frames where the exceptional placement region continuously appears in the candidate frame sequence; and
in response to that the second frame number reaches a second threshold, outputting the warning withdrawal information, wherein the second threshold is less than the first threshold.

14. A warning device, comprising a memory and a processor, wherein the memory stores a computer program capable of running in the processor, and the processor, when executing the program, is configured to:
acquire a first image frame sequence obtained by photographing a game table in a prop operating stage of a game, wherein the game table comprises at least one placement region configured for token placement;
acquire initial information of a token in each the placement region, wherein the initial information of the token comprises information of a token placed by a gamer participating in the game before the game enters the prop operating stage;
detect change information of the token in each the placement region in the prop operating stage based on the first image frame sequence and the initial information of the token; and
give a warning based on the change information of the token in each the placement region.

15. The warning device of claim 14, wherein the computer is further configured to:
acquire a second image frame sequence obtained by photographing the game table in a token placement stage of the game; and
perform at least one of following operations:
in a case of detecting, based on the second image frame sequence, that a game controller operates a game prop in a game prop functional region of the game table, determining that the game enters the prop operating stage; and
in a case of detecting, based on the second image frame sequence, that at least one positionally stable game prop exists in the game prop functional region, determining that the game enters the prop operating stage.

16. The warning device of claim 14, wherein the computer is configured to:
determine a placement region of which the initial information of the token is changed as an exceptional placement region based on the change information of the token in each the placement region; and
output exception warning information, wherein the exception warning information is configured to warn about the change information of the token in the exceptional placement region.

17. The warning device of claim 16, wherein the exception warning information comprises first warning information and second warning information;
wherein the computer is configured to:
output the first warning information in a case where the change information of the token in the exceptional placement region indicates an increase in at least one of a total amount of the token or a total value of the token, wherein the first warning information is configured to indicate that a new token is added to the exceptional placement region in the game prop operating stage; and
output second warning information in a case where the change information of the token in the exceptional placement region indicates a decrease in at least one of the total amount of the token or the total value of the token, wherein the second warning information is configured to indicate that the token in the exceptional placement region is removed in the game prop operating stage.

18. A computer-readable storage medium, storing a computer program, wherein the computer program implements a warning method when executed by the processor, the method comprising:
acquiring a first image frame sequence obtained by photographing a game table in a prop operating stage of a game, wherein the game table comprises at least one placement region configured for token placement;
acquiring initial information of a token in each the placement region, wherein the initial information of the token comprises information of a token placed by a gamer participating in the game before the game enters the prop operating stage;
detecting change information of the token in each the placement region in the prop operating stage based on the first image frame sequence and the initial information of the token; and
giving a warning based on the change information of the token in each the placement region.
